(19) United States
(12) Patent Application Publication
(10) Pub. No.: US 2005/0259347 A1
(43) Pub. Date: Nov. 24, 2005

(54) Method for measuring data tracks on a disk and a head/disk tester using the method

(75) Inventors: Mitsuhiro Nakamura, Hyogo (JP); Takahisa Mihara, Hyogo (JP)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 11/125,735

(22) Filed: May 10, 2005

(30) Foreign Application Priority Data
May 18, 2004 (JP) 2004-147296

(51) Int. Cl. G11B 21/02; G11B 5/596

(52) U.S. Cl. 360/75

(57) ABSTRACT

A method for measuring the track profile in a head-disk tester having a device that rotates the disk and a device that positions a head relative to the disk comprises a step wherein the position of the head on the disk on which a data track and a first servo burst group comprises at least two servo bursts have been written is changed in the direction of the disk radius as the signal amplitude of the data track is measured by the head at each head position and the first servo burst group is read, and the step wherein the measurement results for signal amplitude are mapped at the corresponding position of the head obtained from the readings of this first servo burst group. The magnetic dimensions of the head are found using the track profile obtained by the method.

### BACKGROUND OF THE INVENTION

1. Field of the Invention

The present invention relates to a method and device for testing a disk or a head.

2. Discussion of the Background Art

The magnetic write width (MWW) of write elements on a head, the magnetic read width (MRW) of read elements on a head, and read-write offset (RW-off) between the read and write elements are measurement items relating to the magnetic dimensions of a head. These items are generally measured by a head/disk tester. In further detail, a head is attached to an positioning device of the spinstand mechanism of a tester and the head is measured while moving above a rotating disk. First, data tracks are written with the head positioned at a certain reference position above the disk, then the track average amplitude (TAA) of the data track that has been written is read while the head is moving, and the track profile (TP) is obtained as a function of the travel distance of the head. The MWW is given by the half-height profile width (profile width on the 50% of its peak amplitude), and the RW-off is given by the distance from the middle point of the half-height profile width to the reference position at the time of data track writing. The MRW is obtained, for instance, as follows. First, once a data track has been written, the data track is erased such that 10 to 30% of the MWW remains to create a microtrack and the half-height profile width of the microtrack is measured. The MRW is given by the half-height profile width of the microtrack. The positioning device to which the head is attached has an encoder, a capacitive distance sensor, or another position feedback function in order to precisely position the head.

Causes of measurement errors in the above-mentioned track profile measurement include a relative displacement (thermal drift) between the disk and head due to temperature changes during measurement, a displacement (track mis-registration; TMR) due to non-repeatable runout (NRRO) and disk flutter, a displacement due to external environmental disturbances such as air turbulence, floor vibration and others, electric noise from a TAA demodulation system, quantization error (quantization noise) in data processing, and the like.

Measurement time is desired to be as short as possible in order to surpress the influence of thermal drift. On the other hand, averaging by repeated measurement is necessary in order to surpress the influence of TMR, any external disturbances of relatively high frequencies, and electrical noise. Moreover, it is necessary to increase the number of measurement points in order to improve measurement precision. Consequently, when these requirements are satisfied, measurement time is prolonged and the influence of thermal drift is increased. In addition, it is very difficult to remove components of external disturbances having relatively low frequencies below the frequency corresponding to disk rotational speed.

A tester is now being proposed which compensates thermal drift as one of the error factors (refer to JP (Kokai) 2000-322,850 (page 5, FIG. 5)). This tester positions the head at a position offset from the center of a predetermined track using servo burst signals prewritten on the disk.

The above-mentioned tester requires an additional closed-loop positioning control circuit that responds to the servo burst signals; therefore, the cost of this tester is high in comparison to other testers of the same type.

There is a problem with the above-mentioned tester in that RW-off and similar measurements cannot be measured with high precision. In general the amount of offset, or the distance between the read element and the write element of the head, is several microns. The magnetic write width of today's heads is 0.2 micron. Therefore, the above-mentioned tester must use many servo burst signals to position the head. This tester pre-measures the servo burst signals in order to control positioning. This tester does not compensate for thermal drift that is produced during pre-measurement of the servo burst signals; therefore, there is a large measurement error that is caused by thermal drift produced during the calibration of many servo burst signals.

Thus, an object of the present invention is to provide a method and a device for measuring the track profile with extreme precision without using additional hardware. Another object of the present invention is to provide a method and device for measuring magnetic dimensions such as MWW, MRW, RW-off, and others of a head with extreme precision without using additional hardware.

### SUMMARY OF THE INVENTION

A method for measuring a data track on a disk with a tester used for testing a head and/or a disk, and having a device for rotating a disk and a device for relatively positioning a head to a disk, this method is characterized in that it comprises a step wherein the position of the head on a disk on which a data track and a first servo burst group comprising a plurality of servo bursts have been prewritten is changed in the direction of the disk radius as the data track is measured and the first servo burst group is read by the head at each of these head positions and a step wherein the results of measuring the data track are mapped at the head position obtained from the reading of each corresponding servo burst of the first servo burst group.

An alternative embodiment according to the present invention includes a method for measuring the track profile with a tester used for testing a head and/or a disk, and having a device for rotating a disk and a device for relatively positioning a head to a disk, and this method is characterized in that it comprises a step wherein the position of the head on a disk on which a data track and a first servo burst group comprising a plurality of servo bursts have been prewritten is changed in the direction of the disk radius as the signal amplitude of this data track is measured and the first servo burst group is read by this head at each of these head positions, and a step wherein the results of measuring this signal amplitude are mapped at the head position obtained from the reading of each corresponding servo burst of the first servo burst group.

Either of the aforementioned methods may also comprise a step wherein the first servo burst group is written on the disk; a first calibration step wherein the position of the head on the disk is changed in the direction of the disk radius while the first servo burst group that has been written is read at each head position and positional signals obtained from the reading of each corresponding servo burst of the servo burst group are correlated with the head position; and a step wherein after the first calibration step, the data track is written on the disk, with the mapping step wherein the positional signals are created from the reading of each servo burst of the first servo burst group, the head position is obtained from the positional signals based on the correlation in the first calibration step, and the measurement results are mapped at the resulting head position.

These methods may also comprise a step wherein before writing of the first servo burst group and after first calibration, the head is positioned at the same position by the positioning device, a second servo burst group comprises a plurality of servo bursts prewritten on the disk is read, the head position is obtained from the reading of each corresponding servo burst of the second servo burst group, and the difference between the head position before writing of the first servo burst group and the head position after first calibration is obtained.

These methods further comprise a step wherein a second servo burst group comprises a plurality of servo bursts is written before the first servo burst group is written; a second calibration step wherein the position of the head on the disk is varied in the direction of the disk radius while the second servo burst group that has been written is read at each of the head positions, and the positional signals obtained from the readings of each servo burst of the second servo burst group are correlated with the head position; and a step wherein before writing of the first servo burst group and after first calibration, the head is positioned at the same position by the positioning device, the second servo burst group is read, the head position is obtained from the reading of each servo burst of the second servo burst group based on the correlation in the second calibration step, and the difference between the head position before writing of the first servo burst group and the head position after calibration is obtained.

These methods are characterized in that the processing goes back to the step wherein the first servo burst group is written and the first calibration step is performed when the above-mentioned difference between the head positions exceeds a predetermined value.

These methods are characterized in that the first servo burst group comprises three servo bursts in adjacent rows in the direction of the disk radius, with the servo burst in the middle being at virtually the same position as the data track in the direction of the disk radius.

These methods also are characterized in that they further comprise a step wherein the positional difference between the center of the servo burst in the middle and the center of the data track is obtained.

The present invention also includes a tester used for testing a head and/or a disk, and having a device for rotating a disk and a device for relatively positioning a head to a disk on which a data track is measured, and this tester is characterized in that it comprises means with which the position of the head on a disk on which a data track and a first servo burst group comprising a plurality of servo bursts have been prewritten is changed in the direction of the disk radius as the data track is measured and the first servo burst group is read by this head at each of these head positions and means with which the results of measuring the data track are mapped at the head position obtained from the reading of each corresponding servo burst of the first servo burst group.

An alternative embodiment includes a tester used for testing a head and/or a disk, and having a device for rotating a disk and a device for relatively positioning a head to a disk on which the data track is measured, and this tester is characterized in that it comprises means with which the position of the head on a disk on which a data track and a first servo burst group comprising a plurality of servo bursts have been prewritten is changed in the direction of the disk radius as the signal amplitude of the data track is measured and the first servo burst group is read by the head at each of these head positions and means with which the results of measuring the signal amplitude are mapped at the head position obtained from the reading of each corresponding servo burst of the first servo burst group.

These testers are characterized in that they further comprise means with which the first servo burst group is written on the disk; first calibration means with which the position of the head on the disk is changed in the direction of the disk radius while the first servo burst group that had been written is read at each of the head positions and positional signals obtained from the reading of each corresponding servo burst of the servo burst group are correlated with the head position; and means with which, after the first calibration, the data track is written on the disk, with the mapping means wherein the positional signals are created from the reading of each servo burst of the first servo burst group, the head position is obtained from the positional signals based on the correlation by the first calibration means, and the measurement results are mapped at the resulting head position.

These testers are characterized in that they further comprises means with which before writing of the first servo burst group and after first calibration, the head is positioned at the same position by the positioning device, a second servo burst group comprises a plurality of servo bursts prewritten on the disk is read, the head position is obtained from the reading of each corresponding servo burst of the second servo burst group, and the difference between the head position before writing of the first servo burst group and the head position after first calibration is obtained.

These testers are characterized in that they further comprise means with which a second servo burst group comprises a plurality of servo bursts is written before the first servo burst group is written; second calibration means with which the position of the head on the disk is varied in the direction of the disk radius while the second servo burst group that has been written is read at each of the head positions, and the positional signals obtained from the readings of each servo burst of the second servo burst group are correlated with the head position; and means with which before writing of the first servo burst group and after first calibration, the head is positioned at the same position by the positioning device, the second servo burst group is read, the head position is obtained from the reading of each corresponding servo burst of the second servo burst group based on the correlation from the second calibration means, and the difference between the head position before writing of the first servo burst group and the head position after calibration is obtained.

These testers are characterized in that the first disk writer re-writes the first servo burst on the disk again and the first calibrator re-correlates when the above-mentioned difference between the head positions exceeds a predetermined value.

These testers are characterized in that the first servo burst group comprises three servo bursts in adjacent rows in the direction of the disk radius, with the servo burst in the middle being at virtually the same position as the data track in the direction of the radius of the disk, and in that they further comprise a means wherein the amount of position offset between the center of the servo burst in the middle and the center of the data track is obtained.

These testers are characterized in that the first servo burst group comprises three servo bursts in adjacent rows in the direction of the disk radius, with the servo burst in the middle being at virtually the same position as the data track in the direction of the disk radius.

By means of the present invention, it is possible to very precisely measure the track profile without using additional devices. As a result, it is possible to very precisely measure the magnetic dimensions of a head.

### BRIEF DESCRIPTION OF THE DRAWINGS

FIG. 1 is an oblique view showing the structure of head/disk tester 100 of the present invention.

FIG. 2 is a flow chart showing the procedure whereby the magnetic dimensions of a head are measured in the first embodiment of the present invention.

FIG. 3 is a drawing showing the recording surface of head 300 and disk 200.

FIG. 4 is a drawing showing the recording surface of head 300 and disk 200.

FIG. 5 is a drawing showing the recording surface of head 300 and disk 200.

FIG. 6 is a drawing showing the recording surface of head 300 and disk 200.

FIG. 7 is a drawing showing the recording surface of head 300 and disk 200.

FIG. 8 is a drawing showing the recording surface of head 300 and disk 200.

FIG. 9 is a drawing showing the recording surface of head 300 and disk 200.

FIG. 10 is a drawing showing track profile TPD.

FIG. 11 is a drawing showing mapped partial track profiles CTPD_{D1} and CTP_{D2}.

FIG. 12 is a flow chart showing the procedure for measuring the magnetic dimensions of a head in the second embodiment of the present invention.

FIG. 13 is a drawing showing the recording surface of head 300 and disk 200.

FIG. 14 is a drawing showing the recording surface of head 300 and disk 200.

FIG. 15 is a drawing showing the recording surface of head 300 and disk 200.

FIG. 16 is a drawing showing the recording surface of head 300 and disk 200.

FIG. 17 is a drawing showing the mapped partial track profile CTP_{H1}.

FIG. 18 is a flow chart showing the procedure for measuring the magnetic dimensions of a head in the third embodiment of the present invention.

FIG. 19 is a drawing showing the recording surface of head 300 and disk 200.

FIG. 20 is a drawing showing the recording surface of head 300 and disk 200.

FIG. 21 is a drawing showing PS_{AB} and PS_{BC} lines.

FIG. 22 is a drawing showing the recording surface of head 300 and disk 200.

### DETAILED DESCRIPTION OF THE PREFERRED EMBODIMENT

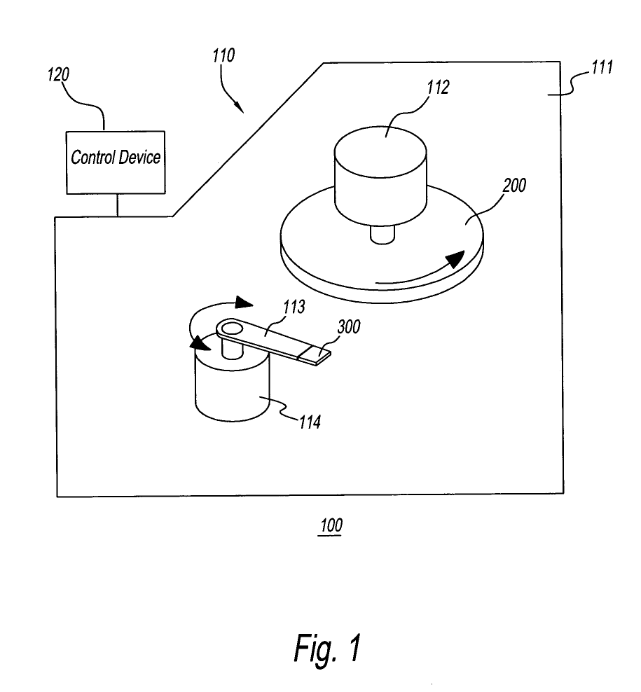

The present invention will now be described based on the preferred embodiments in the attached drawings. The first embodiment of the present invention is a tester for testing a head and/or disk and an oblique view thereof is shown in FIG. 1.

In FIG. 1, a head/disk tester 100 has a spinstand 110 and a control device 120. Spinstand 110 has a base 111, a disk rotating device 112, an arm 113 that supports a head 300, and an positioning device 114. Disk rotating device 112 and positioning device 114 are attached to base 111. Disk rotating device 112 is the device that holds a disk 200 and rotates it at a pre-determined constant speed. Positioning device 114 is the device that rotates and positions arm 113. Positioning device 114 positions arm 113 by feedback control using a position sensor that is not illustrated. Head 300 is positioned relative to disk 200 by the action of arm 113 that is rotated and positioned. Moreover, there are no restrictions to the type of head 300. In short, head 300 can be a slider head, a simple head assembly, or another type of head. Control device 120 is the device that is electrically connected to and controls disk rotating device 112 and positioning device 114. Moreover, control device 120 is electrically connected to head 300 as well and transmits signals to head 300 and receives signals from head 300. Although not illustrated, head-disk tester 100 has a measurement device M that is electrically connected to head 300.

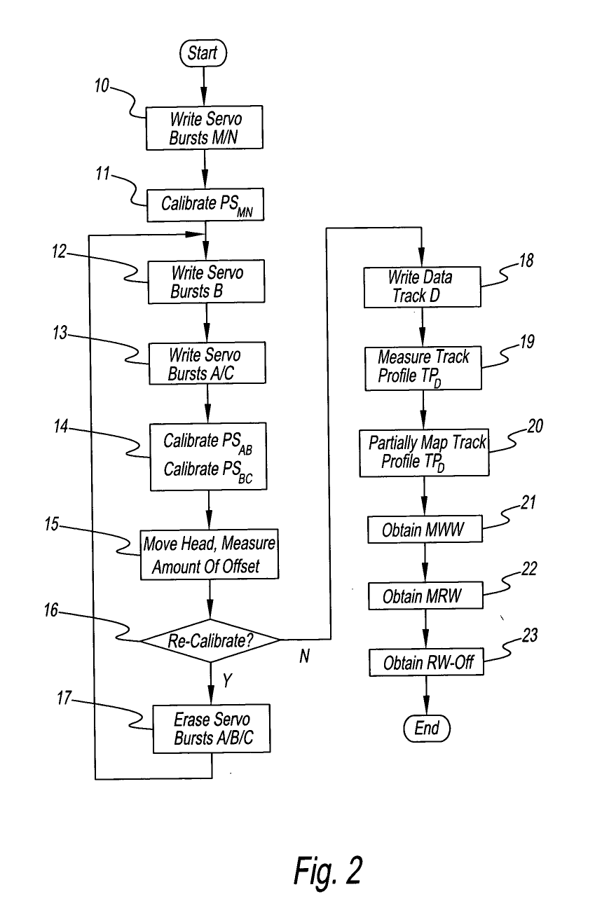

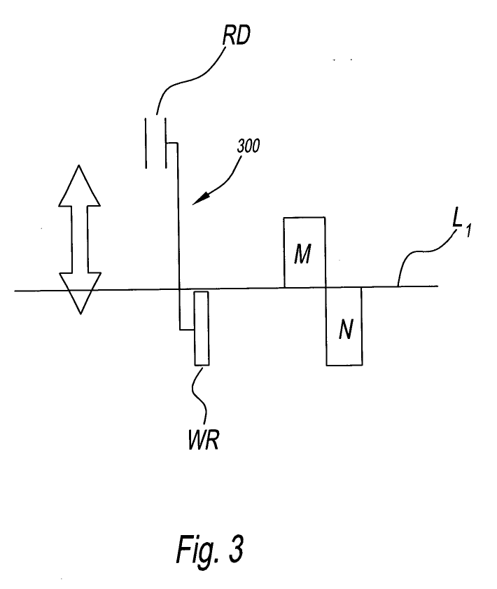

Next, the procedure for measuring the magnetic dimensions of head 300 by head-disk tester 100 structured as described above will now be described. The measurement procedure is as shown in the flow chart in FIG. 2. FIGS. 3 through 9 cited in the following description show the patterns on the recording surface of head 300 on disk 200 and of disk 200. The vertical direction in each of the drawings is the radial direction of the disk 200. The top in each drawing is the outside periphery of disk 200, and the bottom is the inside periphery of disk 200. Moreover, the horizontal direction in each of the drawings is the circumferential direction of disk 200. The same reference symbols are used in each drawing for the elements that are the same as in a previous drawing and a description thereof is omitted.

First refer to FIG. 3. In the figure, head 300 shows only read element RD and write element WR.

A servo burst for detecting the head position on disk 200 is written in Step 10. Specifically, a servo burst M and a servo burst N are written at any position on disk 200 by write element WR. A group consisting of servo burst M and servo burst N is an example of the second servo burst. Servo burst M and servo burst N are written at different positions in the directions of the radius and circumference of disk 200. The amount of offset in the radial direction of disk 200 between servo burst N and servo burst M is the typical value or the design value for MWW of write element WR. This amount of offset can be less than the typical value or design value for the MWW of write element WR in order to improve the linearity of positional signals associated with these servo bursts. The positional signals will be described later. Head 300 moves relatively from the left to the right in the Figure with the rotating of disk 200. Moreover, head 300 is controlled by control device 120 and moves up and down in the Figure. Line L₁ is a line that passes through the middle point between servo burst M and servo burst N extending in the circumferential direction of disk 200.

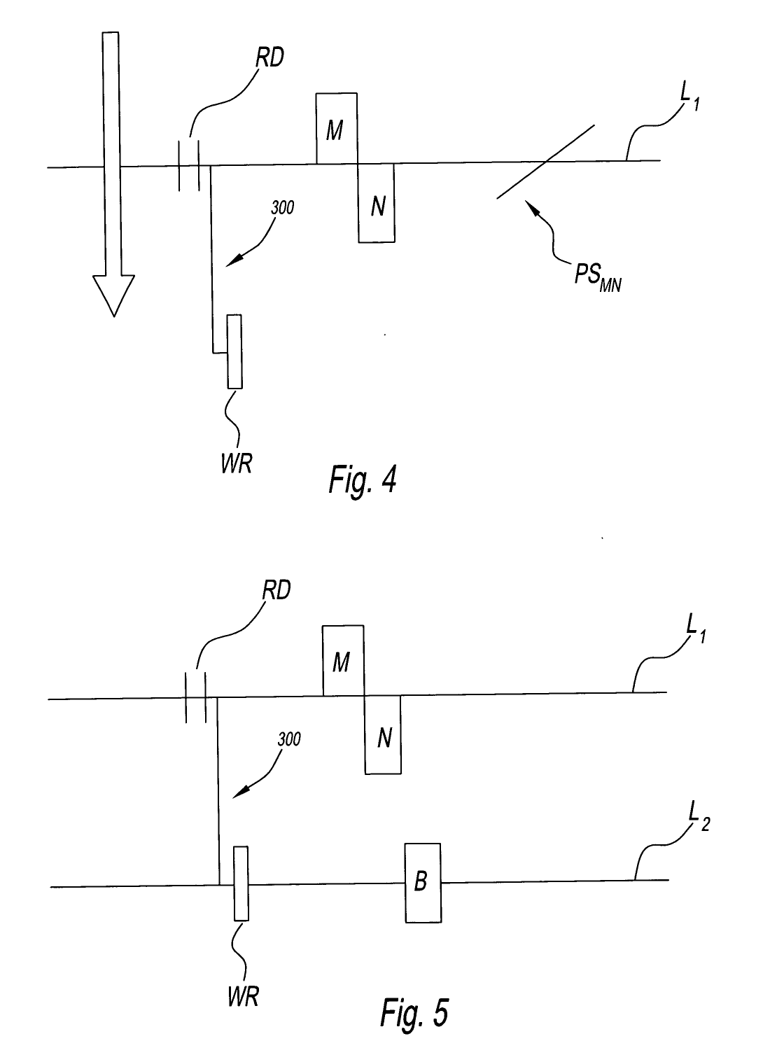

Refer to FIG. 4 next.

Positional signals (PS) associated with servo burst M and servo burst N are calibrated in Step 11. PS signals represent positional information points representing the position of head 300 on disk 200 and are generated by reading the signals recorded on disk 200 with read element RD. PS_{S} are given by the following formula in the present Specification. That is, PS_{JK}, which are positional signals associated with servo burst J and servo burst K, are given by PS_{JK}=(A_{J}−A_{K})/(A_{J}+A_{K}) using the signal amplitude Aj obtained by reading servo burst J and the signal amplitude A_{K} obtained by reading servo burst K. Moreover, the calibration of PS signals is the operation whereby PS signals obtained at a position on disk 200 are correlated with the actual position of head 300 on disk 200. Specifically, it is the creation of a correlation table for PS signals and the actual head positions, or identification of an approximation formula for PS signals and actual head positions. In the present Specification, the calibration of PS signals means finding a and b of a primary approximation formula represented by X=a·P+b when the actual position of head 300 on disk 200 is X and the PS value obtained at a position on disk 200 is P. The position of head 300 recognized by positioning device 114 in the radial direction of disk 200 is referred to in the PS calibration as the actual position of head 300 on disk 200. There are three to five measurement points for calibrating positional signals PS_{MN} relating to servo burst M and servo burst N in the present step, and the averaging of the signal amplitude obtained at each of the measurement point is performed during two or three disk rotations. Moreover, the approximation formula is identified from the resulting average amplitude obtained at each point and the position obtained at each point. The position of each point is the position of head 300 recognized by positioning device 114 in the radial direction of disk 200. Moreover, the primary approximation formula is identified in the following PS calibration in the present specification.

Refer to FIG. 5 next.

Read element RD is moved to a position that is assumed to be on line L₁ and servo bursts M and N are read to obtain PS_{MN1} signals in Step 12. It is also possible to move the read element onto line L₁ using PS_{MN} at this time. The actual position X_{R1} (not illustrated) of head 300 on disk 200 is obtained from the primary approximation formula that was found in Step 11 and PS_{MN1}. A servo burst B is written on disk 200 shortly after reading servo bursts M and N.

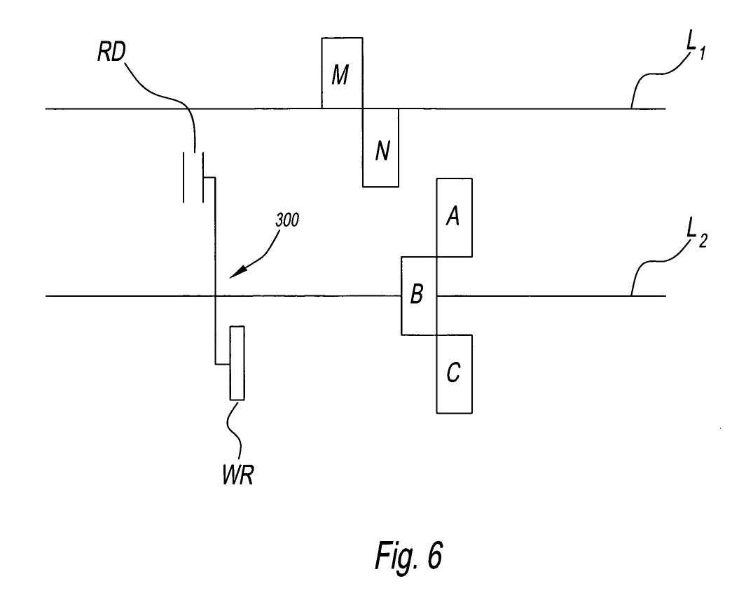

Refer to FIG. 6 next.

Servo bursts A and C are written on disk 200 soon after writing servo burst B, in Step 13. The group consisting of servo bursts A, B, and C is an example of a first servo burst group. Servo bursts A and C are written such that they are adjacent to servo burst G in the radial direction of disk 200. The amount of offset between servo bursts A and B in the radial direction of disk 200, and the amount of offset between servo bursts B and C in the radial direction of disk 200 are the typical values or the design values for the MWW of write element WR. It should be noted that these amounts of offset can also be less than the typical value or design value for the MWW of write element WR in order to improve linearity to the position of the related PS. Line L₂ in the figure is the line extending in the circumferential direction of disk 200 that passes through the middle of servo burst B in the radial direction of disk 200.

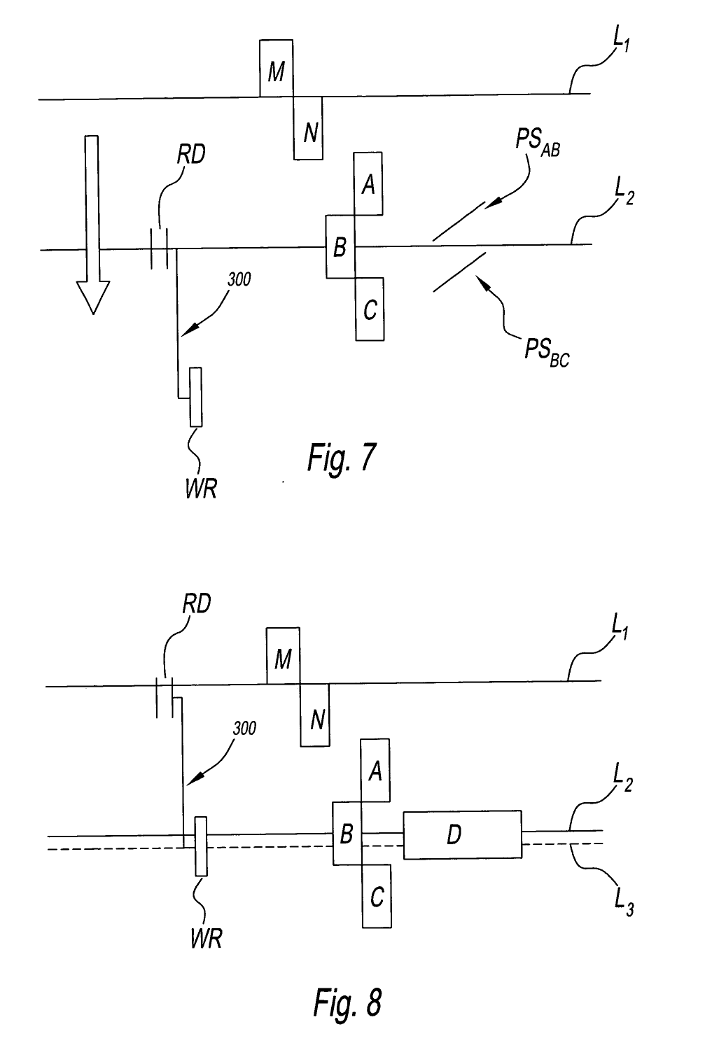

Refer to FIG. 7 next.

Positional signals PS_{AB} related to servo burst A and servo burst B and positional signals PS_{BC} related to servo burst B and servo burst C are continuously calibrated in Step 14. There are three to five measuring points each for calibrating PS_{AB} and PS_{BC} and the averaging of the signal amplitude obtained at each of the measurement point is performed during two or three disk rotations. The primary formula for each PS is identified from the resulting average amplitude of each point and the position of each point. The position of each point is the position of head 300 recognized by positioning device 114 in the radial direction of disk 200, and is a relative position with position X_{R1} (not illustrated) as a reference.

Refer to FIG. 8 next.

Read element RD is moved to a position that is assumed to be on line L₁ and servo bursts M and N are read to obtain PS_{MN2} in Step 15. The actual position X_{R2} (not illustrated) of head 300 on disk 200 is obtained from the primary approximation formula that was found in Step 11 and PS_{MN2}.

The displacement P_{OFF} of head 300 produced during calibration of PS_{AB} and PS_{BC} is obtained in Step 16. The displacement P_{OFF} is found from the difference between position X_{R1} (not illustrated) and position X_{R2} (not illustrated).

The amount of displacement P_{Off} is evaluated in Step 17. If the amount of displacement P_{off} is a predetermined value or less, processing continues to Step 18. If the amount of the displacement P_{off} exceeds a predetermined value, servo bursts A, B, and C that have been written are erased and processing is restarted from Step 12.

Data track D is written on disk 200 by write element WR in Step 18 soon after evaluating the amount of displacement P_{off}. Line L₃ in the figure is the line extending in the circumferential direction of disk 200 that passes through the center of data track D in the radial direction of disk 200. The distance between lines L₂ and L₃ is equal to the distance between positions X_{R1} and X_{R2}.

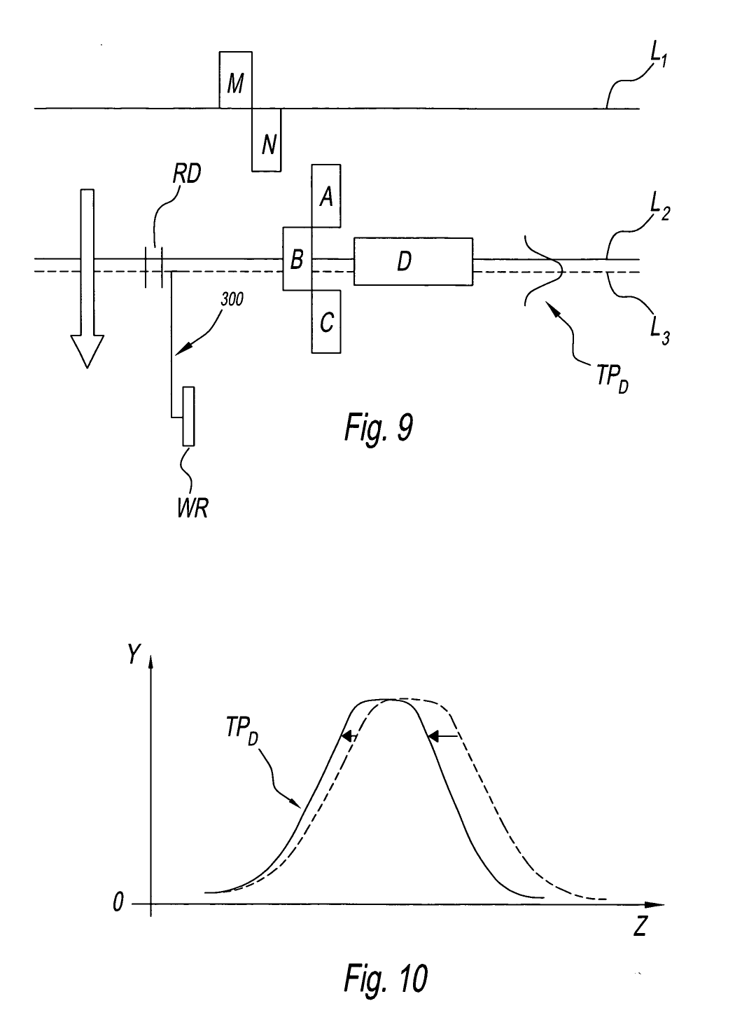

Refer to FIG. 9 next.

Track profile TP_{D} of data track D is measured in Step 19. The average signal amplitude in track units (TAA) of data track D is measured, and at the same time, the servo bursts are read, at each point making up track profile TP_{D}. Moreover, PS_{AB} or PS_{BC} signals are formed from the readings of the servo bursts and the resulting PS_{AB} or PS_{BC} signals are correlated with each measurement point of the track profile. At this time there are 40 to 100 points that make up track profile TP_{D} and the averaging of the signal amplitude obtained at each point is performed during one rotation of disk 200.

Refer to FIG. 10 next. FIG. 10 is a drawing showing track profile TP_{D}. The Y-axis in the figure represents the amplitude of the track profile. Moreover, the Z axis represents the position of head 300 in the radial direction of disk 200 recognized by positioning device 114. Head 300 moves closer to the inside periphery of disk 200 as Z becomes larger. On the other hand, head 300 moves closer to the outside periphery of disk 200 as Z becomes smaller. There are cases where the position of head 300 recognized by positioning device 114 of the head is different from the actual position due to the effect of thermal drift, TMR, and the like. Hereinafter the position of head 300 is assumed to deviate in the direction of the inside periphery of disk 200 over time. Consequently, track profile TP_{D} obtained in step 19 has a distorted shape such that it is squeezed to the left side when compared to the ideal track profile that is obtained when it is assumed that there is no deviation whatsoever in the position of head 300 over time.

Track profile TP_{D} is mapped in Step 20 to the actual position of head 300 on disk 200 obtained from PS_{AB} and PS_{BC} signals based on the correlation in Step 11. Specifically, each point of track profile TP_{D} is mapped to the actual position of head 300 on disk 200 obtained by substituting corresponding PS_{AB} or PS_{BC} signals in the primary approximation formula found in Step 11. PS_{AB} and PS_{BC} signals do not correspond to all points of track profile TP_{D}. Partial track profile CTP_{D1} mapped using PS_{AB} signals and partial track profile CTP_{D2} mapped using PS_{BC} signals are shown in FIG. 11.

Refer to FIG. 11 hereafter. The Y axis in the figure represents the track profile amplitude. The X axis represents the actual position of head 300 on disk 200 in the radial direction of disk 200. Head 300 moves toward the inside periphery of disk 200 as X increases. On the other hand, head 300 moves toward the outside periphery of disk 200 as X decreases.

The MWW of head 300 is found in Step 21. The MWW is found as the half-height width of the track profile. First, the half-value Y_{DH} of the peak value Y_{DP} (not illustrated) of track profile TP_{D} is found. Then points Q_{D1} and Q_{D2} on track profile TP_{D} where the amplitude is Y_{DH} are found. Point Q_{D1} can also be found by simple interpolation between the point closest to amplitude Y_{DH} that is larger than amplitude Y_{DH} and the point closest to amplitude Y_{DH} that is smaller than amplitude Y_{DH} and then applying the primary approximation formula found in Step 11 or the approximation formula identified for a plurality of points in the vicinity of amplitude Y_{DH}. Similarly, point Q_{D2} can be found by simple interpolation between the point closest to amplitude Y_{DH} that is larger than amplitude Y_{DH} and the point closest to amplitude Y_{DH} that is smaller than amplitude Y_{DH} and applying the primary approximation formula found in Step 11 or the approximation formula identified for a plurality of points in the vicinity of amplitude Y_{DH}. In the end, the distance on the X axis between points Q_{D1} and Q_{D2} is found. The resulting distance is the MWW of head 300.

The MRW of head 300 is found in Step 22. The MRW is found by two types of methods. One of the two types of methods is used in the present step. First, the X-intercept X_{D1} of the tangent at point Q_{D1} on track profile CTP_{D1} and the X-intercept X_{D2} of the tangent at point Q_{D2} on track profile CTP_{D2} are found. Moreover, the distance between intercept X_{D1} and intercept X_{D2} is found. The MRW of head 300 is obtained by subtracting the MWW of head 300 from the resulting distance.

The RW-off of head 300 is found in Step 23. First, the median point X_{DC} on the X axis between point Q_{D1} and point Q_{D2} is found. The distance between the position X_{R1} found in Step 12 and point X_{DC} is also found. The RW-off of head 300 is eventually found by subtracting the amount of deviation of data track D with respect to servo burst B (X_{R2}−X_{R1}) from the resulting distance.

The following processing should be applied when an overall mapped track profile is necessary for screen display and the like. Track profile TP_{D} is stretched to the right using the left end as the reference and all points on track profile TP_{D} are mapped to the actual position on disk 200 to create track profile CTP_{D}. At this time, track profile TP_{D} is either stretched to reflect the MWW, MRW, and RW-off found by the above-mentioned procedure, or track profile TP_{D} is stretched such that track profile CTP_{D} overlaps as closely as possible partial track profile CTP_{D1} and partial track profile CTP_{D2}.

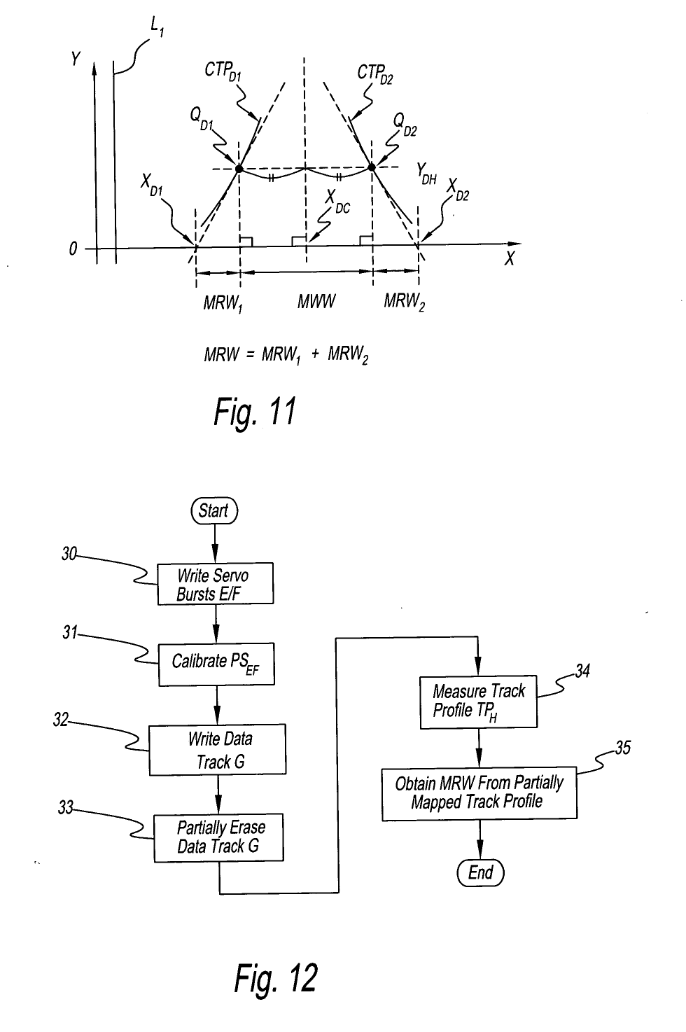

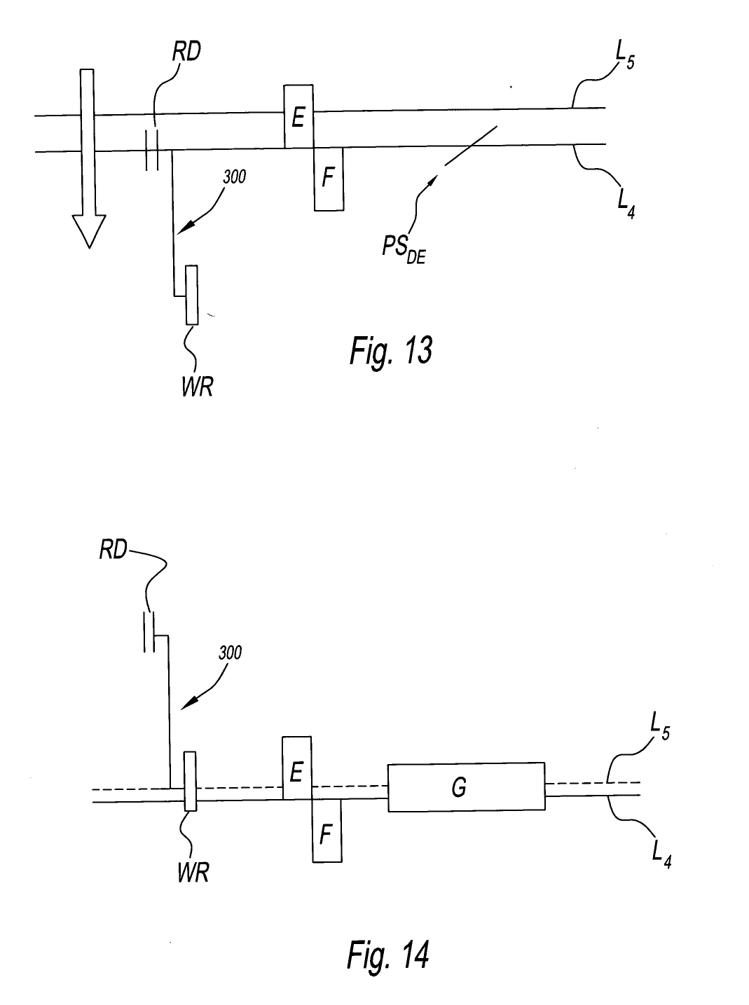

The procedure for measuring the MRW by another method using head/disk tester 100 will now be described as a second embodiment of the present invention. Head-disk tester 100 has the structure that was previously described. The procedure for measuring the MRW in the present embodiment is in accordance with the flow chart in FIG. 12. FIGS. 13 through 16 that are referred to in the following description show head 300 on disk 200 and the patterns on the recording surface of disk 200. The vertical direction in each of the figures is the radial direction of disk 200. The top in each figure is the outside periphery of disk 200, and the bottom is the inside periphery of disk 200. Moreover, the horizontal direction in each of the figures is the circumferential direction of disk 200. The same reference symbols are used in each figure for the elements that are the same as in a previous figure and a description thereof is omitted.

First refer to FIG. 13. In the figure, head 300 shows only read element RD and write element WR.

Servo burst E and servo burst F are written at any position on disk 200 by write element WR. A group consisting of servo burst E and servo burst F is an example of the second servo burst. Servo burst E and servo burst F are written at different positions in the radial and circumferential directions of disk 200. The amount of offset in the radial direction of disk 200 between servo burst N and servo burst M is the typical value or the design value for the MWW of write element WR. This amount of offset can be less than the typical value or design value for the MWW of write element WR in order to improve the linearity of positional signals associated with these servo bursts. Head 300 moves relatively from the left to the right in the figure with the rotating of disk 200. Moreover, head 200 is controlled by control device 120 and moves up and down. Line L₄ is a line that passes through the median point between servo burst E and servo burst F extending in the circumferential direction of disk 200. Line L₅ is the centerline of servo burst E in the radius direction of disk 200, extending in the circumferential direction of disk 200.

Refer to FIG. 14 next.

Positional signals PS_{EF} related to servo bursts E and F are calibrated in Step 31. There are three to five measurement points for calibrating PS_{EF} signals and the averaging of the signal amplitude obtained at each point is performed during two or three rotation of disk 200. The primary approximation formula is identified from the resulting average amplitude of each point and the position of each point. The position of each point is the position of head 300 recognized by positioning device 114 in the radial direction of disk 200.

Write element WR is moved to a position assumed to be on line L₅ and data track G is written on disk 200 in Step 32.

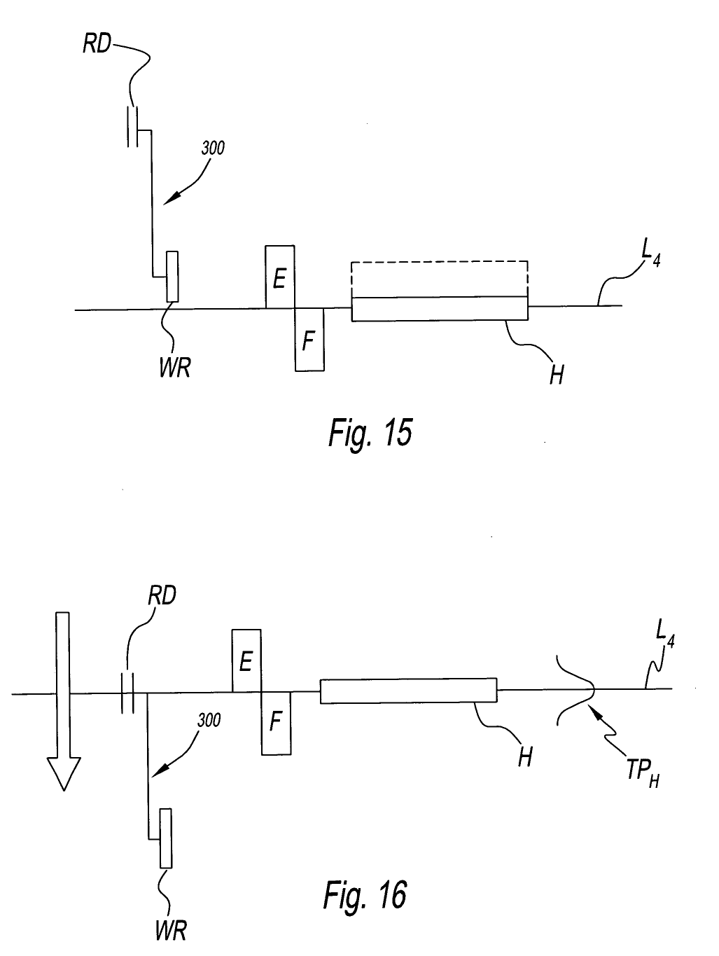

Refer to FIG. 15 next.

Data track G is erased by the write element in Step 33 such that the width of data track G is reduced to approximately 10 to 20% of the original width to form microtrack H. At this time, microtrack H must be near the boundary between servo burst E and servo burst F. Consequently, when the write element WR moves close to the boundary between servo burst E and servo burst F and data track G is written on disk 200 in Step 32, both ends of data track G will be erased in this step to form data track H.

Refer to FIG. 16 next.

Track profile TP_{H} of microtrack H is measured in Step 34. The average signal amplitude in track units (TAA) of data track D is measured at each point making up track profile TP_{H} and at the same time, servo bursts E and F are read. PS_{EF} signals are made from the readings of the servo bursts and these are correlated with each measurement point of track profile TP_{H}. There are 40 to 100 points making up track profile TP_{D} at this time, and the averaging of the signal amplitude obtained at each point is performed during one rotation of disk 200.

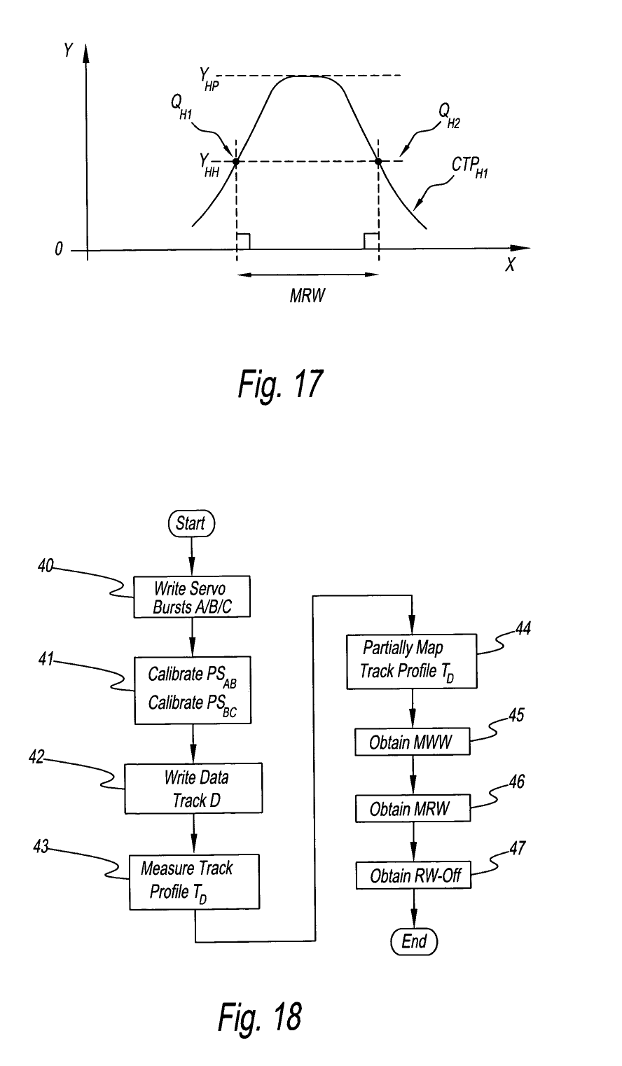

Refer to FIG. 17 next. FIG. 17 shows a partial track profile CTP_{H1} mapped using PS_{EF} signals. As in Step 20, track profile CTP_{H1} is obtained by mapping each point on track profile TP_{H} to the actual position of head 300 on disk 200 obtained by substituting the corresponding PS_{EF} in the primary approximation formula found in Step 31. The Y axis in the figure represents the amplitude of the track profile, and the X axis represents the actual position of head 300 on disk 200 in the radial direction of disk 200. Head 300 moves closer to the inside periphery of disk 200 as X increases. On the other hand, head 300 moves closer to the outside periphery of disk 200 as X decreases.

The MRW of head 300 is found in Step 35. The MRW is found as the half-height width of the microtrack track profile. First, half-height Y_{HH} of peak value Y_{HP} of track profile TP_{H} or track profile CTP_{H1} is found. Then points Q_{H1} and Q_{H2} on track profile CTP_{H1} where the amplitude is Y_{HH} are found. Points Q_{H1} and Q_{H2} can also be found by simple interpolation between the point closest to the amplitude Y_{DH} that is larger than the amplitude Y_{DH} and the point closest to the amplitude Y_{DH} that is smaller than the amplitude Y_{DH} and then applying the primary approximation formula found in Step 11 or the approximation formula identified for a plurality of points neighboring amplitude Y_{HH}. In the end, the distance on the X axis between points Q_{H1} and Q_{H2} is found. The resulting distance is the MRW of head 300.

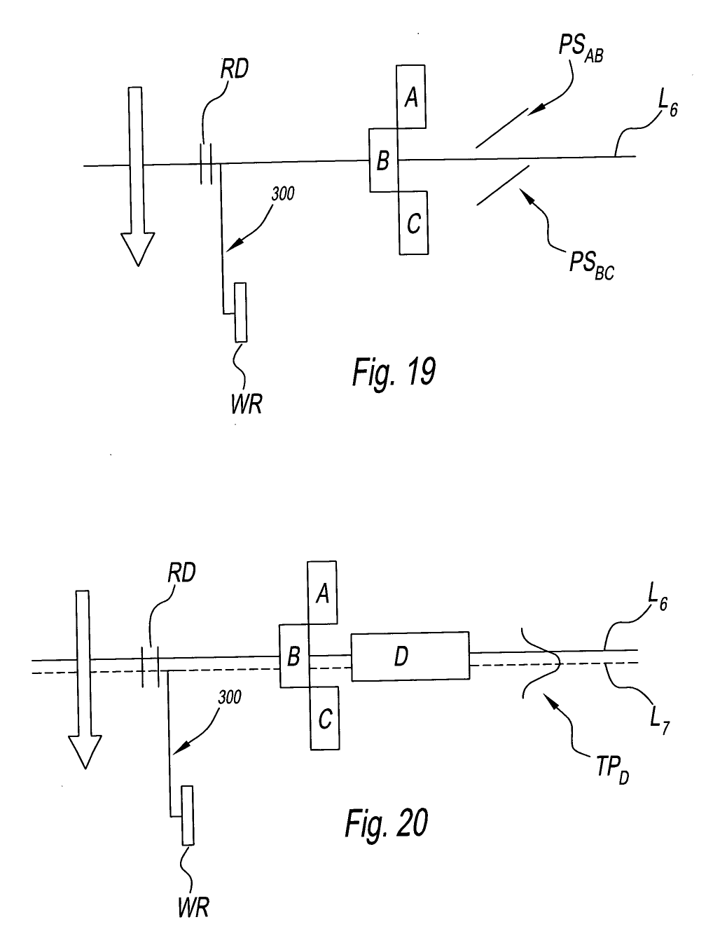

However, several procedures can be omitted from the measurement procedure of the first embodiment if spinstand 110 is mechanically stable. This type of novel measurement procedure is described here for head-disk tester 100 as a third embodiment of the present invention. The measurement procedure in the present embodiment is in accordance with the flow chart in FIG. 18. FIGS. 19 and 20 that are referred to in the following description show the patterns on the recording surface of head 300 on disk 200 and of disk 200. The vertical direction in each of the figures is the radial direction of disk 200. The top in each figure is the outside periphery of disk 200, and the bottom is the inside periphery of disk 200. Moreover, the horizontal direction in each of the drawings is the circumferential direction of disk 200. The same reference symbols are used in FIG. 20 for the elements that are the same as in FIG. 19 and a description thereof is omitted.

First, refer to FIG. 19.

Servo bursts A, B, and C are written at any position on disk 200 by write element WR in Step 40. A group consisting of servo burst E and servo burst F is an example of the second servo burst group. The group consisting of servo bursts A, B, and C is an example of the first servo burst group. Servo bursts A and C are written so that they are next to servo burst B in the radial direction of disk 200. The amount of offset in the radial direction of disk 200 between servo burst A and servo burst B, and the amount of offset between servo burst B and servo burst C in the radial direction of disk 200, are the typical values or the design values for the MWW of the write element WR. These amounts of offset can be less than the typical value or design value for the MWW of write element WR in order to improve the linearity with the position of the related PS signals. Line L₆ is a line extending in the circumferential direction of disk 200 that passes through the middle point at servo burst B in the radial direction of disk 200. X_{R3} is the position (not illustrated) of head 300 recognized by positioning device 114 in the radial direction of disk 200 when servo burst B is written.

Positional signals PS_{AB} related to servo burst A and servo burst B and positional signals PS_{BC} related to servo burst B and servo burst C are continuously calibrated in Step 41. There are four measuring points each for calibrating PS_{AB} and PS_{BC} signals and the averaging of the signal amplitude obtained at each point is performed during two rotation of disk 200. The primary formula for each PS is identified from the resulting average amplitude of each point and the position of each point. The position of each point is the position of head 300 recognized by positioning device 114 in the radial direction of disk 200, and is a relative position with position X_{R3} (not illustrated) as a reference.

Refer to FIG. 20 next.

The write element WR is moved to a position that is assumed to be on line L₇ in Step 42 immediately after calibrating PS_{AB} and PS_{BC} signals and data track D is written on disk 200. Line L₇ in the figure is the line extending in the circumferential direction of disk 200 that passes through the center of data track D in the radial direction of disk 200.

Track profile TP_{D} of data track D is measured in Step 43. When each point making up the track profile is measured, each servo burst is also simultaneously read. PS_{AB} or PS_{BC} signals are formed from the readings of the servo bursts and either the resulting PS_{AB} or PS_{BC} signal is correlated with each measurement point of the track profile. At this time, 40 to 100 points make up the track profile, and the averaging of the signal amplitude obtained at each point is performed during one rotation of disk 200.

Refer to FIG. 11 next. Each element in the figure is as previously described. However, disregard line L₁.

As in Step 20 of FIG. 2, track profile TP_{D} is partially mapped to the actual position of head 300 on disk 200 in Step 44 of FIG. 18. Moreover, as in Step 21 of FIG. 2, the MWW of head 300 is found in Step 45 of FIG. 18. As in Step 22 of FIG. 2, the MRW of head 300 is found in Step 46 of FIG. 18.

The RW-off of head 300 is found in Step 47 of FIG. 18. First, point X_{DC} on the X axis at the median between points Q_{D1} and Q_{D2} is found. The distance between position X_{R3} (not illustrated) and point X_{DC} is found. The RW-off of head 300 is eventually obtained when the amount of deviation of data track D with respect to servo burst B is subtracted from the resulting distance. The amount of deviation in data track D with respect to servo burst B is found as described below.

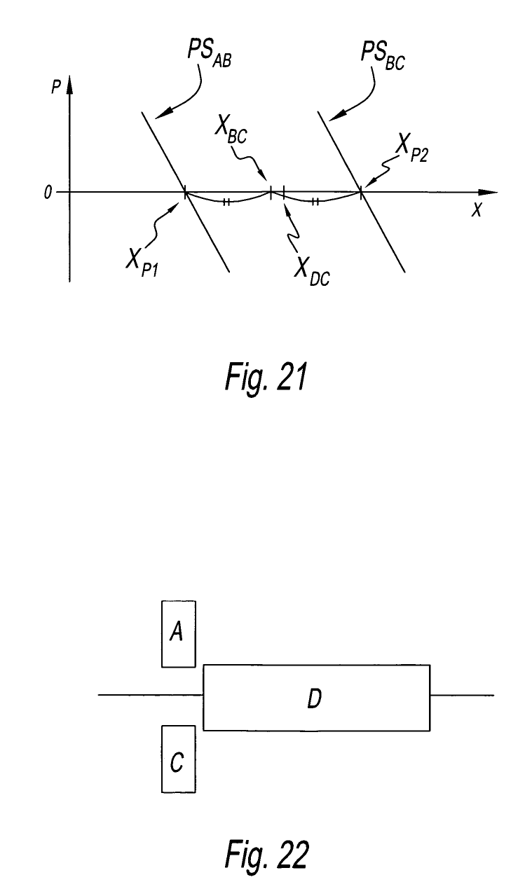

Refer to FIG. 21 hereinafter. FIG. 21 is a drawing showing the profile of PS_{AB} and PS_{BC} signals. The P axis in the figure shows the value of each PS. Moreover, the X axis shows the actual position of head 300 on disk 200 in the radial direction of disk 200. Head 300 moves closer to the inside periphery of disk 200 as X becomes larger. On the other hand, head 300 moves closer to the outside periphery of disk 200 as X becomes smaller.

The X-intercept X_{P1} of PS_{AB} and the X-intercept X_{P2} of PS_{BC} are found in the figure. Moreover, the median point X_{BC} between intercept X_{P1} and intercept X_{P2} is found. Median point X_{BC} can be regarded as included in the centerline of servo burst B in the radial direction of disk 200. Consequently, the amount of deviation of data track D with respect to servo burst B is obtained by finding the distance between median point X_{DC} and median point X_{BC}.

The following modifications and applications are possible in the above-mentioned embodiments.

The number of measurement points for calibrating PS signals and the average time period of each point in the above-mentioned embodiments are not restricted to the above-mentioned ranges. These parameters can be changed as needed as long as the PS of each point is obtained with the desired precision and the deviation in the position of head 300 that is produced when the PS is calibrated is within the allowable range. However, when the PS signals relating to servo bursts M and N are calibrated, it is not necessary to keep in mind the deviation in position of head 300 that is produced when the PS is obtained; therefore, there is a relatively high degree of freedom when setting the number of measurement points for calibrating the PS signals and the average time period of each point. Of course, an extremely long calibration time is out of the question.

Moreover, there is one disk 200 and one head 300 in the above-mentioned embodiments, but there are no restrictions to the number of disks and heads. For instance, a head 310 (not illustrated) can also be used. In this case, the data track and the servo burst can be on different disk surfaces. In short, it is possible to write the servo burst on one side of disk 200, write the data track on the other side of disk 200, read the servo burst with head 300 and measure the data track with head 310. It is also possible to use head 310 and disk 210 (not illustrated). In this case, the data track and servo burst are not necessarily on the same disk.

Servo burst B can be replaced with data track D in the above-mentioned first and third embodiments. In this case, data track D is written in place of servo burst B in step 12, positional signals PS_{AD} and positional signals PS_{DC} are calibrated instead of calibrating PS_{AB} and PS_{BC} signals in Step 14, and the data track is not written in step 18 of the first embodiment. Moreover, data track D is written in place of servo burst B in Step 40, positional signals PS_{AD} and PS_{DC} are calibrated instead of calibrating PS_{AB} and PS_{BC} signals in Step 41, and the data track is not written in Step 42 of the third embodiment. Data track D and servo bursts A and C are written on disk 200 in both embodiments such that they are in adjacent rows in the radial direction of disk 200 as shown in FIG. 22. Moreover, servo burst A is written on the outside periphery side of data track D and servo burst C is written on the inside periphery side of data track D. In this case, the amount of deviation in position of servo burst B and data track D is always zero. Consequently, it is not necessary to adjust the amount of deviation in position between servo burst B and data track D in the above-mentioned embodiments. It should be noted that FIG. 22 shows the pattern on the recording surface of disk 200. The vertical direction in the figure is the direction of disk 200 radius. The top in the figure is the outside periphery side of disk 200 and the bottom is the inside periphery side of disk 200. Moreover, the horizontal direction in each figure shows the circumferential direction of disk 200.

Moreover, servo bursts A and C can be written at different positions in the circumferential direction of disk 200 in the first and third embodiments.

The number of servo bursts and the amount of offset between servo bursts in the above-mentioned embodiments can be changed as needed as long as the calibration of the related positional information can be performed with the desired precision. For instance, the amount of offset between servo bursts can be reduced and the number of servo bursts can be increased in order to support a wide range of servo bursts in the radial direction of disk 200. However, each servo burst must be written such that positional signals PS are obtained near both ends of data track D or near both ends of microtrack H in the radial direction of disk 200 in order to map the slope on both sides of track profile TP_{D} or track profile TP_{H}. Moreover, measurement errors increase with an increase in the number of servo bursts; therefore, a smaller number of servo bursts is preferred.

The number of points at which track profile TP_{D} and track profile TP_{H} and the average number of times (or average time period) at each measurement point can be increased as needed in the above-mentioned embodiments.

When a table showing the correlation between the PS and the actual head position is drafted for PS calibrations in the above-mentioned embodiments, each point on the track profile is mapped to the actual position of head 300 on disk 200 obtained by simple interpolation from a table drafted using the PS_{AB} or PS_{BC} corresponding to each point on the track profile during the mapping of the track profile.

Moreover, with regard to the positional information in the above-mentioned embodiments, PS_{JK}, which is the positional signal related to servo burst J and servo burst K, is given by PS_{JK}=(A_{J}−A_{K})/(A_{J}+A_{K}) using the signal amplitude A_{J} obtained by reading servo burst J and the signal amplitude A_{K} obtained by reading servo burst K. However, the position information can also be obtained by other formulas. For instance, it can be given by PS_{JK}=A_{J}/A_{K}.

There is only one group of servo bursts and a data track or a microtrack in the circumferential direction of disk 200 in the above-mentioned embodiments, but two or more groups can also be present in the circumferential direction of disk 200. In other words, there can be servo bursts and a data track present in every sector and the track profile and magnetic dimensions can be measured for each sector.

The track profile measuring method of the present invention can be used to measure the magnetic dimensions of a head as well as for other measurements of the track profile. For instance, the track profile measuring method of the present invention can be used for triple track tests.

The measuring method of the present invention can be used for head/disk testers that have an X-Y positioning mechanism, head/disk testers that have an X-θ positioning mechanism, or another type of head/disk tester.

The present invention can be used for applications that measure a data track with a head at each head position while varying the position of the head on the disk in the direction of the disk radius. For instance, the present invention can be used when measuring the profile related to the error rate in data tracks in the direction of track width (direction of the disk radius).

1. A method for measuring a data track on a disk with a tester for testing a head and/or a disk, said tester having a device for rotating a disk and a device for positioning a head with a disk, said method comprising:
changing the position of the head on a disk on which a data track and a first servo burst group comprising a plurality of servo bursts have been prewritten in the direction of the disk radius as said data track is measured and the first servo burst group is read by the head at each of the head positions; and
mapping the results of measuring the data track at the head position obtained from the reading of each corresponding servo burst of the first servo burst group.

2. The method according to claim 1, further comprising:
writing the first servo burst group on said disk;
changing, via a first calibration step, the position of said head on the disk in the direction of the disk radius while the first servo burst group that had been written is read at each of the head positions and positional signals obtained from the reading of each corresponding servo burst of the servo burst group are correlated with the head position; and
after said first calibration step, writing the data track on the disk,
with said mapping being a step wherein the positional signals are created from the reading of each servo burst of the first servo burst group, the head position is obtained from the positional signals based on the correlation in the first calibration step, and the measurement results are mapped at the resulting head position.

3. The method according to claim 2, further comprising:
before writing of the first servo burst group and after first calibration, positioning said head at the same position by the positioning device, a second servo burst group comprising a plurality of servo bursts prewritten on the disk is read, the head position is obtained from the reading of each corresponding servo burst of the second servo burst group, and the difference between the head position before writing of the first servo burst group and the head position after first calibration is obtained.

4. The method according to claim 2, further comprising:
writing a second servo burst group comprising a plurality of servo bursts before the first servo burst group is written;
varying, via a second calibration step, the position of the head on the disk in the direction of the radius of said disk while the second servo burst group that has been written is read at each of the head positions, and the positional signals obtained from the readings of each servo burst of the second servo burst group are correlated with the head position; and
before writing of the first servo burst group and after first calibration, positioning the head at the same position by the positioning device, the second servo burst group is read, the head position is obtained from the reading of each corresponding servo burst of the second servo burst group based on the correlation in the second calibration step, and the difference between the head position before writing of the first servo burst group and the head position after calibration is obtained.

5. The method according to claim 3, wherein processing goes back to the step wherein the first servo burst group is written and the first calibration step follows when the above-mentioned difference between the head positions exceeds a predetermined value.

6. The method according to claim 1, wherein said first servo burst group comprises three servo bursts in adjacent rows in the direction of the radius of the disk, with the servo burst in the middle being at virtually the same position as the data track in the radial direction of the disk.

7. The method according to claim 6, wherein said method further comprises finding the position difference in the direction of the disk radius between the center of the servo burst in the middle and the center of the data track is obtained.

8. A method for measuring the track profile with a tester for testing a head and/or disk, this tester having a device for rotating a disk and a device for positioning a head with a disk, said method comprising:
a step wherein the position of the head on a disk on which a data track and a first servo burst group comprising a plurality of servo bursts have been prewritten is changed in the direction of the disk radius as the signal amplitude of this data track is measured and the first servo burst group is read by the head at each of the head positions; and
a step wherein the results of measuring the signal amplitude are mapped at the head position obtained from the reading of each corresponding servo burst of the first servo burst group.

9. The method according to claim 8, further comprising:
writing the first servo burst group on said disk;
changing, via a first calibration step, the position of said head on the disk in the direction of the disk radius while the first servo burst group that had been written is read at each of the head positions and positional signals obtained from the reading of each corresponding servo burst of the servo burst group are correlated with the head position; and
after said first calibration step, writing the data track on the disk,
with said mapping being a step wherein the positional signals are created from the reading of each servo burst of the first servo burst group, the head position is obtained from the positional signals based on the correlation in the first calibration step, and the measurement results are mapped at the resulting head position.

10. The method according to claim 9, further comprising:
before writing of the first servo burst group and after first calibration, positioning said head at the same position by the positioning device, a second servo burst group comprising a plurality of servo bursts prewritten on the disk is read, the head position is obtained from the reading of each corresponding servo burst of the second servo burst group, and the difference between the head position before writing of the first servo burst group and the head position after first calibration is obtained.

11. The method according to claim 9, further comprising:
writing a second servo burst group comprising a plurality of servo bursts before the first servo burst group is written;
varying, via a second calibration step, the position of the head on the disk in the direction of the radius of said disk while the second servo burst group that has been written is read at each of the head positions, and the positional signals obtained from the readings of each servo burst of the second servo burst group are correlated with the head position; and
before writing of the first servo burst group and after first calibration, positioning the head at the same position by the positioning device, the second servo burst group is read, the head position is obtained from the reading of each corresponding servo burst of the second servo burst group based on the correlation in the second calibration step, and the difference between the head position before writing of the first servo burst group and the head position after calibration is obtained.

12. The method according to claim 10, wherein processing goes back to the step wherein the first servo burst group is written and the first calibration step follows when the above-mentioned difference between the head positions exceeds a predetermined value.

13. The method according to claim 8, wherein said first servo burst group comprises three servo bursts in adjacent rows in the direction of the radius of the disk, with the servo burst in the middle being at virtually the same position as the data track in the radial direction of the disk.

14. The method according to claim 13, wherein said method further comprises finding the position difference in the direction of the disk radius between the center of the servo burst in the middle and the center of the data track is obtained.

15. A tester for testing a head and/or a disk having a device for rotating a disk and a device for positioning a head with a disk with which the data track on the disk is measured, said tester comprising:
first disk reader with which the position of the head on a disk on which a data track and a first servo burst group comprises a plurality of servo bursts have been prewritten is changed in the direction of the disk radius as the data track is measured and the first servo burst group is read by the head at each of the head positions; and
first processor with which the results of measuring the data track are mapped at the head position obtained from the reading of each corresponding servo burst of the first servo burst group.

16. The tester according to claim 15, further comprising:
first disk writer with which the first servo burst group is written on the disk;
a first calibrator with which the position of the head on the disk is changed in the direction of the disk radius while the first servo burst group that had been written is read at each of the head positions and positional signals obtained from the reading of each corresponding servo burst of the servo burst group are correlated with the head position; and
second disk writer with which after the first calibration, the data track is written on the disk,
with said first processor wherein these positional signals are created from the reading of each servo burst of said first servo burst group, said head position is obtained from these positional signals based on the correlation in said first calibration, and these measurement results are mapped at this resulting head position.

17. The tester according to claim 16, further comprising:
second disk reader with which before writing of the first servo burst group and after first calibration, the head is positioned at the same position by the positioning device, a second servo burst group comprising a plurality of servo bursts prewritten on the disk is read, the head position is obtained from the reading of each corresponding servo burst of the second servo burst group, and the difference between the head position before writing of the first servo burst group and the head position after first calibration is obtained.

18. The tester according to claim 16, further comprising:
third disk writer with which a second servo burst group comprises a plurality of servo bursts is written before the first servo burst group is written;
a second calibrator with which the position of the head on the disk is varied in the direction of the radius of this disk while the second servo burst group that has been written is read at each of the head positions, and the positional signals obtained from the readings of each servo burst of the second servo burst group are correlated with the head position; and
third disk reader with which before writing of the first servo burst group and after first calibration, the head is positioned at the same position by the positioning device, the second servo burst group is read, the head position is obtained from the reading of each corresponding servo burst of the second servo burst group based on the correlation from the second calibrator, and the difference between the head position before writing of the first servo burst group and the head position after calibration is obtained.

19. The tester according to claim 17, wherein said first disk writer re-writes the first servo burst on the disk again and said first calibrator re-correlates when the above-mentioned difference between the head positions exceeds a predetermined value.

20. The tester according to claim 15, wherein said first servo burst group comprises three servo bursts in adjacent rows in the radial direction of the disk, with the servo burst in the middle being at virtually the same position as the data track in the radial direction of the disk.

21. The tester according to claim 20, further comprising second processor finding the position difference in the direction of the disk radius between the center of the servo burst in the middle and the center of the data track is obtained.

22. A tester for testing a head and/or a disk having a device for rotating a disk and a device for positioning a head with a disk with which the data track on the disk is measured, this tester characterized in that it comprises
first disk reader with which the position of the head on a disk on which a data track and a first servo burst group comprises a plurality of servo bursts have been prewritten is changed in the direction of the disk radius as the signal amplitude of the data track is measured and the first servo burst group is read by the head at each of the head positions and
first processor with which the results of measuring the signal amplitude are mapped at the head position obtained from the reading of each corresponding servo burst of the first servo burst group.

23. The tester according to claim 22, further comprising:
first disk writer with which the first servo burst group is written on the disk;
a first calibrator with which the position of the head on the disk is changed in the direction of the disk radius while the first servo burst group that had been written is read at each of the head positions and positional signals obtained from the reading of each corresponding servo burst of the servo burst group are correlated with the head position; and
second disk writer with which after the first calibration, the data track is written on the disk,
with said first processor wherein these positional signals are created from the reading of each servo burst of said first servo burst group, said head position is obtained from these positional signals based on the correlation in said first calibration, and these measurement results are mapped at this resulting head position.

24. The tester according to claim 23, further comprising:
second disk reader with which before writing of the first servo burst group and after first calibration, the head is positioned at the same position by the positioning device, a second servo burst group comprising a plurality of servo bursts prewritten on the disk is read, the head position is obtained from the reading of each corresponding servo burst of the second servo burst group, and the difference between the head position before writing of the first servo burst group and the head position after first calibration is obtained.

25. The tester according to claim 23, further comprising:
third disk writer with which a second servo burst group comprises a plurality of servo bursts is written before the first servo burst group is written;
a second calibrator with which the position of the head on the disk is varied in the direction of the radius of this disk while the second servo burst group that has been written is read at each of the head positions, and the positional signals obtained from the readings of each servo burst of the second servo burst group are correlated with the head position; and
third disk reader with which before writing of the first servo burst group and after first calibration, the head is positioned at the same position by the positioning device, the second servo burst group is read, the head position is obtained from the reading of each corresponding servo burst of the second servo burst group based on the correlation from the second calibrator, and the difference between the head position before writing of the first servo burst group and the head position after calibration is obtained.

26. The tester according to claim 24, wherein said first disk writer re-writes the first servo burst on the disk again and said first calibrator re-correlates when the above-mentioned difference between the head positions exceeds a predetermined value.

27. The tester according to claim 22, wherein said first servo burst group comprises three servo bursts in adjacent rows in the radial direction of the disk, with the servo burst in the middle being at virtually the same position as the data track in the radial direction of the disk.

28. The tester according to claim 27, further comprising second processor finding the position difference in the direction of the disk radius between the center of the servo burst in the middle and the center of the data track is obtained.
